(19) United States
(12) Patent Application Publication
(10) Pub. No.: US 2025/0372641 A1
(43) Pub. Date: Dec. 4, 2025

(54) Positive Electrode Active Material, Secondary Battery, and Method of Producing Positive Electrode Active Material

(71) Applicant: TOYOTA JIDOSHA KABUSHIKI KAISHA, Toyota-shi Aichi-ken (JP)

(72) Inventor: Ryosuke OHSAWA, Okazaki-shi Aichi-ken (JP)

(73) Assignee: TOYOTA JIDOSHA KABUSHIKI KAISHA, Toyota-shi Aichi-ken (JP)

(21) Appl. No.: 19/218,763

(22) Filed: May 27, 2025

(30) Foreign Application Priority Data
May 31, 2024 (JP) 2024-088832

(51) Int. Cl. H01M 4/525; C01G 53/506; H01M 10/0525

(52) U.S. Cl. CPC H01M 4/525; C01G 53/506; H01M 10/0525; C01P 2002/50; C01P 2004/20; C01P 2006/40

(57) ABSTRACT

A positive electrode active material comprises a lithium-metal composite oxide. The lithium-metal composite oxide is in a form of a plate-like particle. The plate-like particle satisfies relationships of “3≤dx/dz” and “2≤dy/dz”. “dx” represents a major-axis diameter of the plate-like particle. “dy” represents a minor-axis diameter of the plate-like particle. “dz” represents a thickness of the plate-like particle.

### CROSS REFERENCE TO RELATED APPLICATIONS

This nonprovisional application is based on Japanese Patent Application No. 2024-088832 filed on May 31, 2024, with the Japan Patent Office, the entire contents of which are hereby incorporated by reference.

### BACKGROUND OF THE DISCLOSURE

### Field of the Disclosure

The present disclosure relates to a positive electrode active material, a secondary battery, and a method of producing a positive electrode active material.

### Description of the Background Art

Japanese Patent Laying-Open No. 2017-228438 discloses metal oxide particles in which the difference in pore volume for pore sizes from 10 to 40 nm is 0.01 cm³/g or more.

### SUMMARY OF THE DISCLOSURE

There is a demand for reducing battery resistance. For example, regulating the pore structure of active material particles is expected to increase the reaction area.

With the reaction area thus increased, battery resistance is expected to be reduced. However, there is still room for improvement in battery resistance.

An object of the present disclosure is to reduce battery resistance.

Hereinafter, the technical configuration and effects of the present disclosure will be described. It should be noted that the action mechanism according to the present disclosure includes presumption. The action mechanism does not limit the technical scope of the present disclosure.

1. A positive electrode active material comprises a lithium-metal composite oxide. The lithium-metal composite oxide is in a form of a plate-like particle. The plate-like particle satisfies relationships of “3≤dx/dz” and “2≤dy/dz”. “dx” represents a major-axis diameter of the plate-like particle. “dy” represents a minor-axis diameter of the plate-like particle. “dz” represents a thickness of the plate-like particle.

When the lithium-metal composite oxide forms plate-like particles of a particular type, battery resistance is expected to be reduced. It may be because many entrance sites for lithium (Li) are formed in a main face, which is one of the outer surfaces of each particle that has the largest area. With the reaction area thus increased, battery resistance is expected to be reduced.

2. The positive electrode active material according to “1” above may include the following configuration, for example. The plate-like particle further satisfies a relationship of “0.21≤dy·dz≤0.29”.

“dy·dz” corresponds to the ratio of the area of the main face to a first aspect ratio (dx/dz). When “dy·dz” is from 0.21 to 0.29, battery resistance is expected to be reduced. 3. The positive electrode active material according to “1” or “2” above may include the following configuration, for example. The lithium-metal composite oxide has a lamellar-rock-salt-type structure.

When the lithium-metal composite oxide has a lamellar-rock-salt-type structure, entrance sites for Li tend to be concentrated on the main face of the plate-like particle.

4. The positive electrode active material according to any one of “1” to “3” above may include the following configuration, for example. The lithium-metal composite oxide has a composition represented by the following general formula.

Li₁₋ₐMO₂

In the above general formula, a relationship of −0.5≤a≤0.5 is satisfied. M includes at least one selected from the group consisting of Ni, Co, Mn, and Al.

5. The positive electrode active material according to any one of “1” to “4” above may include the following configuration, for example. The plate-like particle consists of a single crystallite.

6. A secondary battery comprises the positive electrode active material according to any one of “1” to “5” above.

7. A method of producing a positive electrode active material comprises the following (a) to (c):
(a) preparing a metal hydroxide;
(b) mixing the metal hydroxide, a lithium compound, and a flux agent to form a mixture; and
(c) performing heat treatment of the mixture in an oxygen atmosphere to synthesize a lithium-metal composite oxide.

The flux agent includes at least one selected from the group consisting of Li₂SO₄, NaCl, CaCl, LiCl, and LiNO₃. In the (c), the lithium-metal composite oxide grows into a plate-like particle.

When a particular flux agent is used, anisotropic growth is expected to be facilitated. When anisotropic growth is facilitated, plate-like crystals (plate-like particles) may be formed.

8. The method of producing a positive electrode active material according to “7” above may include the following configuration, for example. In the (b), a ratio of an amount of substance of the flux agent to an amount of substance of the metal hydroxide is from 0.1 to 1.

When the ratio of the amount of substance of the flux agent is from 0.1 to 1, anisotropic growth is expected to be facilitated.

9. The method of producing a positive electrode active material according to “7” or “8” above may include the following configuration, for example. In the (c), a first heat treatment and a second heat treatment are performed in this order. A temperature in the second heat treatment is 1.2 to 1.4 times a temperature in the first heat treatment. A duration of the second heat treatment is 0.1 to 0.5 times a duration of the first heat treatment.

When a particular two-step heat treatment (two-step calcination) is performed, anisotropic growth is expected to be facilitated.

In the following, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating a plate-like particle.

FIG. 2 is a conceptual view illustrating a first example of the particle shape.

FIG. 3 is a conceptual view illustrating a second example of the particle shape.

FIG. 4 is a schematic flowchart illustrating a method of producing a positive electrode active material according to the present embodiment.

FIG. 5 is a conceptual view illustrating a secondary battery according to the present embodiment.

FIG. 6 is a table showing a first battery configuration.

FIG. 7 is a table showing a second battery configuration.

FIG. 8 is a table showing a third battery configuration.

FIG. 9 is a table showing experiment results.

### DESCRIPTION OF THE EMBODIMENTS

### Terms and Phrases

Terms such as “comprise”, “include”, and “have”, and other similar terms are open-ended terms. In an open-ended term, in addition to a stated component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. For example, as long as substantially the same function is obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤”. Each of “more than” and “less than” is represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

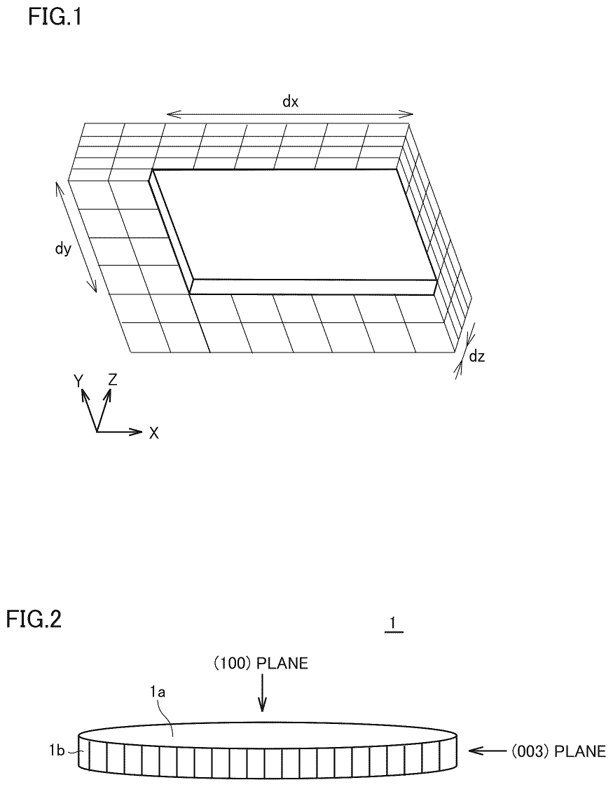

“Plate-like particle” refers to a particle that has a plate-like outer shape. FIG. 1 is a conceptual view illustrating a plate-like particle. The particle shape may be identified by three-dimensional SEM (Scanning Electron Microscope) examination. For example, by using the Live3D function of an SEM manufactured by JEOL under the trade name of “JSM-IT710HR”, it is possible to create a 3D image of the particle. The smallest rectangular parallelepiped circumscribing the 3D image of the particle (hereinafter also called “a circumscribing rectangular parallelepiped”) is identified. When the circumscribing rectangular parallelepiped is plate-like, the particle is regarded as “a plate-like particle”. Two faces of the circumscribing rectangular parallelepiped having the largest area are regarded as “bottom faces”. Each bottom face is rectangular. The rectangle includes a square. An axis parallel to the long side of the rectangle is the X axis. The length of the long side is regarded as “a major-axis diameter (dx)”. An axis parallel to the short side of the rectangle is the Y axis. The length of the short side is regarded as “a minor-axis diameter (dy)”. The Z axis is orthogonal to the XY plane. The distance between the two bottom faces is regarded as “a thickness (dz)”. Among the faces of each particle that face a bottom face of the circumscribing rectangular parallelepiped, a face having the largest area is regarded as “a main face”. A face that crosses the main face is regarded as “a side face”. A side face may or may not be orthogonal to the main face. The portion of connection between a side face and the main face may be smooth, and in this case, the boundary between the side face and the main face may not be clearly identified.

“Crystallite” refers to a solid particle that is the smallest constituent unit of a particle, and it is recognized that the boundary between them cannot be split any further.

“D50” refers to a particle size in volume-based particle size distribution (cumulative distribution) at which the cumulative value reaches 50%. The particle size distribution may be measured by laser diffraction.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any molar ratio, unless otherwise specified. For example, the compound may be doped with a trace element. Some of Al and O may be replaced by another element.

“Derivative” refers to a compound that is derived from its original compound by at least one partial modification selected from the group consisting of substituent introduction, atom replacement, oxidation, reduction, and other chemical reactions.

The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

### Positive Electrode Active Material

In the following, a positive electrode active material according to the present embodiment may be simply referred to as “the present positive electrode active material”. The present positive electrode active material is for a secondary battery. The present positive electrode active material comprises a lithium-metal composite oxide. The lithium-metal composite oxide is in the form of plate-like particles. The present positive electrode active material may be a group of particles (powder). The powder may consist of plate-like particles.

In addition to the plate-like particles, the powder may further include particles that are not plate-like (other-shape particles). The other-shape particles may be spherical, cubic, rod-like, in lumps, and/or the like, for example. The composition of the other-shape particles may be the same as that of the plate-like particles. The composition of the other-shape particles may be different from that of the plate-like particles. For example, the powder may include the plate-like particles in a mass fraction of 5% or more, with the remainder being made up of the other-shape particles. The mass fraction of the plate-like particles may be 10% or more, or 20% or more, or 30% or more, or 40% or more, or 50% or more, or 60% or more, or 70% or more, or 80% or more, or 90% or more, or 95% or more, or 99% or more, for example.

The D50 of the present positive electrode active material may be 0.1 μm or more, or 1 μm or more, or 3 μm or more, for example. The D50 may be 20 μm or less, or 10 μm or less, or 5 μm or less, or 3 μm or less, for example.

### Plate-Like Particles

The plate-like particles may be non-aggregated particles (single particles), for example. The plate-like particles may be in the form of aggregated particles (secondary particles), for example. The aggregated particles may include 2 to 20, or 2 to 10, or 2 to 5 plate-like particles, for example.

### Shape

The shape of a particle viewed in a direction parallel to the Z axis is referred to as a planar shape. The planar shape of the plate-like particle is not particularly limited. The planar shape may be polygonal, elliptical, circular, and/or the like, for example. The polygonal shape may be triangular, tetragonal (rectangular, square, rhombic), pentagonal, hexagonal, octagonal, and/or the like, for example.

As illustrated in FIG. 1, the plate-like particle has a major-axis diameter (dx), a minor-axis diameter (dy), and a thickness (dz). The plate-like particle has a specific shape. More specifically, the plate-like particle satisfies the relationships of “3≤dx/dz” and “2≤dy/dz”.

“dx/dz” is also called “a first aspect ratio”. “dx/dz” refers to the aspect ratio of the XZ plane. “dx/dz” may be 3.2 or more, or 4.6 or more, or 5.3 or more, for example. “dx/dz” may be 5.3 or less, or 4.6 or less, or 3.2 or less, for example.

“dy/dz” is also called “a second aspect ratio”. “dy/dz” refers to the aspect ratio of the YZ plane. “dy/dz” may be 2.5 or more, or 3.6 or more, or 4.7 or more, for example. “dy/dz” may be 4.7 or less, or 3.6 or less, or 2.5 or less, for example.

“dx/dy” is also called “a third aspect ratio”. “dx/dy” refers to the aspect ratio of the XY plane. “dx/dy” may be 1 or more, or 1.1 or more, or 1.2 or more, or 1.5 or more, or 1.8 or more, for example. “dx/dy” may be 3 or less, or 2 or less, or 1.8 or less, or 1.5 or less, or 1.2 or less, or 1.1 or less, for example.

The major-axis diameter (dx) may be 500 nm or more, or 1 μm or more, or 5 μm or more, or 10 μm or more, for example. The major-axis diameter (dx) may be 20 μm or less, or 10 μm or less, or 5 μm or less, or 1 μm or less, for example.

The minor-axis diameter (dy) may be 50 nm or more, or 100 nm or more, or 500 nm or more, or 1 μm or more, or 5 μm or more, for example. The minor-axis diameter (dy) may be 10 μm or less, or 5 μm or less, or 1 μm or less, or 500 nm or less, or 100 nm or less, for example.

The thickness (dz) may be 10 nm or more, or 50 nm or more, or 100 nm or more, or 500 nm or more, or 1 μm or more, for example. The thickness (dz) may be 5 μm or less, or 1 μm or less, or 500 nm or less, or 100 nm or less, or 50 nm or less, for example.

“dy.dz” corresponds to the ratio of the area of the main face to the first aspect ratio (dx/dz). By substituting the area of the bottom face of the circumscribing rectangular parallelepiped (dx dy) for the area of the main face, it is possible to derive “dy.dz”. “dy.dz” may be 0.01 or more, or 0.03 or more, or 0.05 or more, or 0.07 or more, or 0.10 or more, or 0.15 or more, or 0.20 or more, or 0.21 or more, or 0.23 or more, or 0.25 or more, or 0.27 or more, or 0.29 or more, or 0.30 or more, or 0.35 or more, or 0.40 or more, for example. “dy.dz” may be less than 0.44, or 0.43 or less, or 0.40 or less, or 0.35 or less, or 0.30 or less, or 0.29 or less, or 0.27 or less, or 0.25 or less, or 0.23 or less, or 0.21 or less, or 0.20 or less, or 0.15 or less, or 0.10 or less, or 0.07 or less, or 0.05 or less, or 0.03 or less, for example. “dy.dz” may be from 0.21 to 0.29, for example.

### Crystal Structure

The plate-like particle may consist of a single crystallite (a single crystal), for example. The lithium-metal composite oxide may have any crystal structure. The lithium-metal composite oxide may have a lamellar-rock-salt-type structure, for example. A lamellar-rock-salt-type structure is also called “an α-NaFeO₂-type structure”. The space group for a lamellar-rock-salt-type structure is “R-3m”. It should be noted that the bar “-” should be placed above “3” but for the sake of convenience, it is placed in front of “3”. The crystal structure may be identified by powder X-ray diffraction (XRD).

For example, the main face of each plate-like particle may be substantially parallel to a 100 plane. The 100 plane may be orthogonal to each layer of the lamellar-rock-salt-type structure. Gaps between the layers of the lamellar-rock-salt-type structure may serve as entrance sites for Li. When the main face is parallel to the 100 plane, entrance sites for Li tend to be concentrated on the main face. As a result, battery resistance is expected to be reduced. On the other hand, a 003 plane may be parallel to each layer of the lamellar-rock-salt-type structure. The 003 plane tends not to serve as an entrance site for Li. For example, the 100 plane may be called “an active surface”. For example, the 003 plane may be called “an inactive surface”. When the particle is plate-like, the 100 plane tends to be parallel to the main face. On the other hand, when the particle is rod-like or the like, a side face (a peripheral surface) may become the main face (having the largest area). When the particle is rod-like or the like, the 003 plane tends to be parallel to the main face.

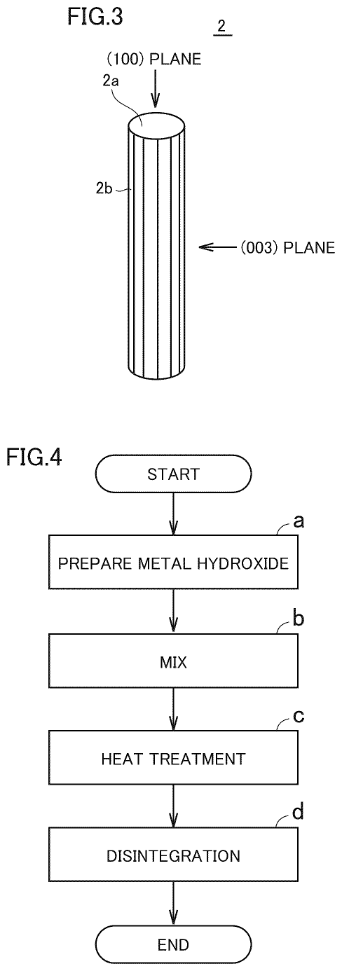

FIG. 2 is a conceptual view illustrating a first example of the particle shape. FIG. 3 is a conceptual view illustrating a second example of the particle shape. In FIG. 2, a first particle 1 may be a plate-like particle. The area of a main face 1a (a plate-like face) is larger than the area of a side face 1b (a peripheral surface). Main face la may be parallel to the 100 plane. Side face 1b may be parallel to the 003 plane. In FIG. 3, a second particle 2 may be a rod-like particle. The area of an end face 2a is smaller than the area of a side face 2b (a peripheral surface). End face 2a may be parallel to the 100 plane. Side face 2b may be parallel to the 003 plane. It is conceivable that the active surface (a 100 plane) takes up a large area of the outer surface of each first particle 1, as compared to each second particle 2. With first particle 1, battery resistance is expected to be reduced, as compared to second particle 2.

### 100-Plane Dominance

“100-Plane dominance” may be measured by the procedure described below. By transmission electron microscopy (TEM), a powder sample is examined. Within the field of view, ten particles are randomly selected. For each selected particle, the face that apparently has the largest area (the main face) is examined. The number of particles with a 100 plane detected on the main face by TEM analysis is divided by the total number of the particles, to determine the 100-plane dominance. The 100-plane dominance is expressed in percentage. The 100-plane dominance may be 50% or more, or 60% or more, or 70% or more, or 80% or more, or 90% or more, or 100%, for example. When the 100-plane dominance is 50% or more, it is considered that a dominant crystal face in the sample is a 100 plane (an active surface). When the active surface is dominant, battery resistance is expected to be reduced, for example.

By TEM analysis of a side face of the plate-like particle, a 003 plane (inactive surface) may be detected, for example.

### Chemical Composition

The lithium-metal composite oxide may have any chemical composition. The lithium-metal composite oxide may have a composition represented by the following general formula, for example.

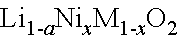

In the formula, the relationship of −0.5≤a≤0.5 is satisfied. M includes at least one selected from the group consisting of Ni, Co, Mn, and Al.

The composition of the lithium-metal composite oxide may be represented by the following general formula, for example.

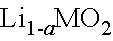

In the above formula, the relationships of −0.5≤a≤0.5, 03x≤1 are satisfied. M may include, for example, at least one selected from the group consisting of Co, Mn, and Al. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The lithium-metal composite oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

The composition of the lithium-metal composite oxide may be represented by the following general formula, for example. A compound represented by the following general formula may also be called “NCM”.

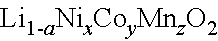

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.5}Mn_{0.5}O₂.

The composition of the lithium-metal composite oxide may be represented by the following general formula, for example. A compound represented by the following general formula may also be called “NCA”.

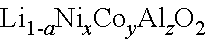

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

To the lithium-metal composite oxide, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the amount-of-substance fraction relative to the total amount of the positive electrode active material) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

The dopant may be an atom derived from a flux agent, which is described below. The dopant may include at least one selected from the group consisting of S, Na, Ca, Cl, and N, for example.

The ratio of the amount of substance of an atom derived from the flux agent to the amount of substance of the lithium-metal composite oxide may be 0.01 or more, or 0.05 or more, or 0.1 or more, for example. This ratio may be 0.5 or less, or 0.1 or less, or 0.05 or less, for example.

### Method of Producing Positive Electrode Active Material

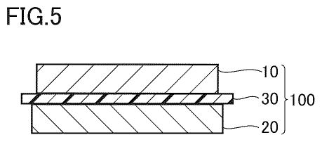

FIG. 4 is a schematic flowchart illustrating a method of producing a positive electrode active material according to the present embodiment. In the following, the method of producing a positive electrode active material according to the present embodiment may be simply referred to as “the present production method”. The present production method includes “(a) preparing a metal hydroxide”, “(b) mixing”, and “(c) heat treatment”. The present production method may further include “(d) disintegration” and/or the like, for example.

### (a) Preparing Metal Hydroxide

The present production method includes preparing a metal hydroxide. The metal hydroxide is a precursor of a lithium-metal composite oxide. The metal hydroxide may be synthesized by coprecipitation and/or the like, for example. A sulfate may be prepared, for example. The sulfate may include at least one selected from the group consisting of NiSO₄, CoSO₄, MnSO₄, and Al₂(SO₄)₃, for example.

The sulfate is dissolved in water to prepare a raw material solution. The mass concentration of the raw material solution may be from 10 to 50%, for example. The raw material solution may be added dropwise to an alkaline aqueous solution to precipitate the metal hydroxide. The precipitate (the metal hydroxide) may be collected by filtration, for example. After collected, the metal hydroxide may be rinsed with water. After rinsed with water, the metal hydroxide may be dried.

### (b) Mixing

The present production method includes mixing the metal hydroxide, a lithium compound, and a flux agent to form a mixture. The materials may be mixed and pulverized in a mortar and/or the like, for example.

“Lithium compound” refers to a Li-containing compound. The lithium compound may include at least one selected from the group consisting of LiOH and Li₂CO₃, for example. The lithium compound is a Li source for the lithium-metal composite oxide. The ratio of the amount of substance of Li to the amount of substance of the metal hydroxide (precursor) may be 0.5 or more, or 0.75 or more, or 1 or more, or 1.1 or more, or 1.25 or more, for example. This ratio may be 1.5 or less, or 1.25 or less, or 1.1 or less, or 1 or less, or 0.75 or less, for example.

The flux agent includes at least one selected from the group consisting of Li₂SO₄, NaCl, CaCl, LiCl, and LiNO₃. It is conceivable that the flux agent facilitates plate-like anisotropic growth during heat treatment. That is, the lithium-metal composite oxide grows into plate-like particles. The ratio of the amount of substance of the flux agent to the amount of substance of the metal hydroxide (precursor) may be from 0.1 to 1, for example. This ratio may be 0.5 or more, or may be 0.5 or less, for example.

### (c) Heat Treatment

The present production method includes performing heat treatment of the mixture in an oxygen atmosphere to synthesize a lithium-metal composite oxide. The heat treatment is also called “calcination”. The heat treatment may be performed with any heat treatment apparatus. For example, an electric furnace, a muffle furnace, and/or the like may be used.

For example, two-step heat treatment may be performed. More specifically, a first heat treatment and a second heat treatment may be performed in this order. As compared to the first heat treatment, the second heat treatment may be performed at a high temperature in a short time. The temperature in the second heat treatment may be from 1.2 to 1.4 times the temperature in the first heat treatment, for example. The duration of the second heat treatment may be from 0.1 to 0.5 times the duration of the first heat treatment.

The temperature in the first heat treatment may be from 600 to 900° C., for example. The duration of the first heat treatment may be from 8 to 12 hours, for example.

The temperature in the second heat treatment may be from 950 to 1100° C., for example. The duration of the second heat treatment may be from 2 to 6 hours, for example.

### (d) Disintegration

The present production method may include disintegration of the lithium-metal composite oxide. Any mill (for example, a jet mill) may be used. By disintegration, the particle size of the lithium-metal composite oxide may be regulated.

### Others

For example, when the present positive electrode active material is for an all-solid-state battery, the plate-like particles may be subjected to coating treatment. The coating material may include LiNbO₃, LiTiO₃, Li₃PO₄, and/or the like, for example. The coating treatment may be performed by a mechanochemical method, a spray drying method, and/or the like, for example.

### Secondary Battery

FIG. 5 is a conceptual view illustrating a secondary battery according to the present embodiment. A battery 100 is a secondary battery. “Secondary battery” refers to a rechargeable battery. Battery 100 includes a positive electrode 10, a negative electrode 20, and an electrolyte. Battery 100 may further include a separator 30. Positive electrode 10 includes the present positive electrode active material. That is, battery 100 includes the present positive electrode active material. As long as it includes the present positive electrode active material, battery 100 may have any configuration. Battery 100 may be a liquid-type battery, a polymer battery, or an all-solid-state battery, for example. Battery 100 may be a monopolar battery or a bipolar battery, for example. Positive electrode 10 and negative electrode 20 may form a power generation element. “Power generation element” may also be called a power storage element, an electrode assembly, an electrode group, and the like. The power generation element may be either a wound-type one or a stack-type one, for example.

### Exterior Package

Battery 100 may include an exterior package. The exterior package may accommodate the power generation element. The exterior package may be a case made of metal, a pouch made of a laminated film, and/or the like, for example. The case may have any shape. The case may be cylindrical, prismatic, flat, coin-shaped, and/or the like, for example. The exterior package may include Al and/or the like, for example.

### Positive Electrode

The positive electrode may be in sheet form, for example. The positive electrode may include a base material and a positive electrode active material layer, for example. The base material is electrically conductive. The base material is capable of supporting the positive electrode active material layer. The base material may be in sheet form, for example. The base material may have a thickness from 5 to 50 μm, for example. The base material may include a metal foil sheet, for example. The base material may include at least one selected from the group consisting of Al, Mn, Ti, Fe, and Cr, for example. The base material may include an Al foil sheet, an Al alloy foil sheet, a Ti foil sheet, a stainless steel (SUS) foil sheet, and/or the like, for example.

Between the base material and the positive electrode active material layer, an intermediate layer may be formed. The intermediate layer does not include a positive electrode active material. The intermediate layer may have a thickness from 0.1 to 5 μm, for example. The intermediate layer may include a conductive material, an insulation material, a binder, and/or the like, for example. The conductive material may include carbon black and/or the like, for example. The insulation material may include alumina, boehmite, aluminum hydroxide, and/or the like, for example. The binder may include polyvinylidene difluoride (PVdF) and/or the like, for example.

The positive electrode active material layer may be placed on the surface of the base material. The positive electrode active material layer may be placed on only one side of the base material. The positive electrode active material layer may be placed on both sides of the base material. The thickness of the positive electrode active material layer may be from 10 to 1000 μm, or from 50 to 500 μm, or from 100 to 300 μm, for example. The positive electrode active material layer includes the present positive electrode active material. The positive electrode active material layer may further include another positive electrode active material in addition to the present positive electrode active material. This another positive electrode active material may include lithium iron phosphate and/or the like, for example. The mass fraction of the present positive electrode active material with respect to all the positive electrode active materials may be 10% or more, or 20% or more, or 30% or more, or 40% or more, or 50% or more, or 60% or more, or 70% or more, or 80% or more, or 90% or more, for example.

The positive electrode active material layer may further include a conductive material, a binder, and the like, for example. The amount of the conductive material to be used may be, for example, from 0.1 to 10 parts by mass relative to 100 parts by mass of the positive electrode active material. The conductive material may include any component. The conductive material may include at least one selected from the group consisting of graphite, acetylene black (AB), Ketjenblack (registered trademark), vapor grown carbon fibers (VGCFs), carbon nanotubes (CNTs), and graphene flakes (GFs), for example.

The amount of the binder to be used may be, for example, from 0.1 to 10 parts by mass relative to 100 parts by mass of the positive electrode active material. The binder may include any component. The binder may include at least one selected from the group consisting of PVdF, vinylidene difluoride-hexafluoropropylene copolymer (PVdF-HFP), PTFE, carboxymethylcellulose (CMC), polyacrylic acid (PAA), polyvinyl alcohol (PVA), polyvinylpyrrolidone (PVP), polyoxyethylene alkyl ether, and derivatives of these, for example.

The positive electrode active material layer may further include an inorganic filler, an organic filler, a solid electrolyte, a surface modifier, a dispersant, a lubricant, a flame retardant, a protective agent, a flux agent, a coupling agent, an adsorbent, and/or the like, for example. The positive electrode active material layer may include polyoxyethylene allylphenyl ether phosphate, zeolite, silane coupling agent, MoS₂, WO₃, and/or the like, for example.

### Negative Electrode

Negative electrode 20 may be in sheet form, for example. The negative electrode may include a base material and a negative electrode active material layer, for example. The base material is capable of supporting the negative electrode active material layer. The base material may have a thickness from 5 to 50 μm, for example. The base material may include at least one selected from the group consisting of Cu and Ni, for example. The base material may include a Cu foil sheet, a Cu alloy foil sheet, a Ni foil sheet, and/or the like, for example.

The negative electrode active material layer may be placed on the surface of the base material. The negative electrode active material layer may be placed on only one side of the base material. The negative electrode active material layer may be placed on both sides of the base material. The thickness of the negative electrode active material layer may be from 10 to 1000 μm, or from 50 to 500 μm, or from 100 to 300 μm, for example. The negative electrode active material layer includes a negative electrode active material. The negative electrode active material layer may further include a conductive material, a binder, and the like, for example.

The amount of the conductive material to be used may be, for example, from 0.1 to 10 parts by mass relative to 100 parts by mass of the negative electrode active material. The conductive material may include any component. The conductive material may include at least one selected from the group consisting of AB, Ketjenblack, VGCFs, CNTs, and GFs, for example.

The amount of the binder to be used may be, for example, from 0.1 to 10 parts by mass relative to 100 parts by mass of the negative electrode active material. The binder may include any component. The binder may include, for example, at least one selected from the group consisting of styrene-butadiene rubber (SBR), acrylate butadiene rubber (ABR), sodium alginate, CMC (such as CMC—H, CMC—Na, CMC—Li, CMC—NH₄), PAA (such as PAA—H, PAA—Na, PAA—Li), polyacrylonitrile (PAN), PVDF, PTFE, acrylic resin, methacrylic resin, PVP, PVA, and derivatives of these. For example, the expression “CMC—Na” refers to a Na salt of CMC. For example, the expression “CMC—H” refers to an acid-type CMC. The same applies to “PAA—Na” and the like.

The negative electrode active material layer may further include an inorganic filler, an organic filler, a solid electrolyte, a surface modifier, a dispersant, a lubricant, a flame retardant, a protective agent, a flux agent, a coupling agent, an adsorbent, and/or the like, for example. The negative electrode active material layer may include a layered silicate (such as smectite, montmorillonite, bentonite, hectorite), an inorganic filler (such as solid alumina, hollow silica, boehmite), a polysiloxane compound, and/or the like, for example.

The negative electrode active material may be in particle form, or may be in sheet form, for example. The D50 of the negative electrode active material may be from 1 to 30 μm, or from 10 to 20 μm, or from 1 to 10 μm, for example.

The negative electrode active material may include a carbon-based active material, for example. The carbon-based active material may include at least one selected from the group consisting of graphite, soft carbon, and hard carbon, for example. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The graphite may include a dopant. The dopant may include, for example, at least one selected from the group consisting of B, N, P, Li, and Ca. The amount thereof to be added in amount-of-substance fraction may be from 0.01 to 5%, or from 0.1 to 3%, or from 0.1 to 1%, for example.

The surface of the graphite may be covered with amorphous carbon, for example. The surface of the graphite may be covered with another type of material, for example. This another type of material may include, for example, at least one selected from the group consisting of P, W, Al, and O. The another type of material may include, for example, at least one selected from the group consisting of Al(OH)₃, AlOOH, Al₂O₃, WO₃, Li₂CO₃, LiHCO₃, and Li₃PO4.

The negative electrode active material may include an alloy-based active material, for example. The negative electrode active material may include, for example, at least one selected from the group consisting of Si, Li silicate, SiO, Si-based alloy, Sn, SnO, and Sn-based alloy.

SiO may be represented by the following general formula, for example.

SiOₓ

In the formula, the relationship of 0<x<2 is satisfied. For example, the relationship of 0.5≤x≤1.5 or 0.8≤x≤1.2 may be satisfied.

Li silicate may include at least one selected from the group consisting of Li₄SiO₄, Li₂SiO₃, Li₂Si₂O₅, and Li₈SiO₆, for example. The negative electrode active material may include a mixture of Si and Li silicate, for example. The mixing ratio (mass ratio) may be “Si/(Li silicate)=1/9 to 9/1”, or “Si/(Li silicate)=2/8 to 8/2”, or “Si/(Li silicate)=3/7 to 7/3”, or “Si/(Li silicate)=4/6 to 6/4”, for example.

The alloy-based active material (such as Si, SiO) may include an additive. The additive may be a substituted solid solution atom or an intruding solid solution atom, for example. The additive may be an adherent adhered to the surface of the alloy-based active material. The adherent may be an elementary substance, an oxide, a carbide, a nitride, a halide, and/or the like, for example. The amount to be added may be, in amount-of-substance fraction, from 0.01 to 5%, or from 0.1 to 3%, or from 0.1 to 1%, for example. The additive may include, for example, at least one selected from the group consisting of Li, Na, K, Rb, Be, Mg, Ca, Sr, Fe, Ba, B, Al, Ga, In, C, Ge, Sn, Pb, N, P, As, Y, Sb, and S. That is, SiO may be doped with Mg and/or Na. For example, Mg silicate and/or Na silicate may be formed. For example, boron oxide (such as B₂O₃, for example), yttrium oxide (such as Y₂O₃, for example), and/or the like may be added to SiO.

The negative electrode active material may include a composite material of the carbon-based active material (such as graphite) and the alloy-based active material (such as Si), for example. A composite material including Si and carbon may also be called “an Si—C composite material”. For example, Si microparticles may be dispersed inside carbon particles. For example, Si microparticles may be dispersed inside graphite particles. For example, Li silicate particles may be covered with a carbon material (such as amorphous carbon).

The negative electrode active material may include, for example, at least one selected from the group consisting of Li metal, Li-based alloy, and Li₄Ti₅O₁₂. The negative electrode active material may include a Li foil sheet and/or the like, for example.

### Liquid Electrolyte (Electrolyte Solution)

Battery 100 may include an electrolyte solution. In other words, battery 100 may be a liquid-type battery. The electrolyte solution includes a supporting salt and a solvent. The supporting salt is also called “a supporting electrolyte”. The concentration of the supporting salt (salt concentration) may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The supporting salt may include an inorganic acid salt, an imide salt, an oxalato complex, a halide, and/or the like, for example. The supporting salt may include at least one selected from the group consisting of LiPF₆, LiBF₄, LiClO₄, LiAsF₆, LiSbF₆, LiN(SO₂F)₂ “LiFSI”, LiN(SO₂CF₃)₂ “LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these, for example.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{E M C} + {V}_{D M C} + {V}_{DEC} = 10$$

In the equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7 ”, “EC/DMC=3/7”, “EC/FEC/DEC=1/2/7”, “EC/DMC/EMC-3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite(ES), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the supporting salt and the solvent may be used as a trace component (an additive). The additive may include, for example, at least one selected from the group consisting of LiBF₄, LiFSI, LiTFSI, LiBOB, LiDFOB, LiDFOP, LiPO₂F₂, FSO₃Li, Lil, LiBr, HFE, DOX, PC, FEC, and derivatives of these.

The electrolyte may include an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### Gelled Electrolyte

The electrolyte solution and a polymer material may form a gelled electrolyte.

In other words, battery 100 may be a polymer battery. The polymer material may form a polymer matrix. The polymer material may include, for example, at least one selected from the group consisting of PVdF, PVdF-HFP, PAN, PVdF-PAN, polyethylene oxide (PEO), polyethylene glycol (PEG), and derivatives of these.

### Solid Electrolyte

Battery 100 may include a solid electrolyte. In other words, battery 100 may be an all-solid-state battery. The solid electrolyte may be in powder form, for example. The D50 of the solid electrolyte may be from 0.1 to 3 μm, for example.

The solid electrolyte may include a sulfide solid electrolyte, for example. The sulfide solid electrolyte may be glass ceramic, or may be argyrodite, for example. The sulfide solid electrolyte may include at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₇P₃S₁₁, Li₃PS₄, Li₇PS₆, and Li₆PS₅X (X=Cl, Br, I), for example.

For example, “LiI—LiBr—Li₃PS₄” refers to a sulfide solid electrolyte produced by mixing “LiI, LiBr, and Li₃PS₄” in a freely-selected molar ratio. For example, the sulfide solid electrolyte may be produced by a mechanochemical method. “Li₂S-P₂S₅” includes Li₃PS₄. Li₃PS₄ may be produced by mixing Li₂S and P₂S₅ in “a molar ratio of Li₂S/P₂S₅=75/25”, for example.

The solid electrolyte may include a halide solid electrolyte, for example. The halide solid electrolyte may have a composition represented by the following general formula, for example.

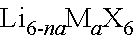

In the formula, n represents the oxidation number of M. For example, M may include an atom whose oxidation number is +3. For example, M may include an atom whose oxidation number is +4. M may include at least one selected from the group consisting of Y, Al, Ti, Zr, Ca, and Mg, for example. The relationship of 0<a<2 may be satisfied. X may include at least one selected from the group consisting of F, Cl, Br, and I, for example.

The halide solid electrolyte may have a composition represented by the following general formula, for example.

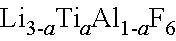

In the formula, the relationship of 0≤a≤0.1, 0.1≤a≤0.2, 0.2≤a≤0.3, 0.3≤a≤0.4, 0.4≤a≤0.5, 0.5≤a≤0.6, 0.6≤a≤0.7, 0.7≤a≤0.8, 0.8≤a≤0.9, or 0.9≤a≤1 may be satisfied, for example.

The halide solid electrolyte may have a composition represented by the following general formula, for example.

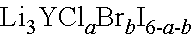

In the formula, the relationship of O≤a+b≤6 is satisfied. For example, the relationship of 0≤a≤1, 1≤a≤2, 2≤a≤3, 3≤a≤4, 4≤a≤5, or 5≤a≤6 may be satisfied. For example, the relationship of 0sb≤1, 1sb≤2, 2sb≤3, 3sb≤4, 4sb≤5, or 5sb≤6 may be satisfied.

The solid electrolyte may include an oxide solid electrolyte, for example. The oxide solid electrolyte may include at least one selected from the group consisting of LiNbO₃, Li_{1.5}Al_{0.5}Ge_{1.5}(PO₄)₃, La_{2/3-x}Li₃ₓTiO₃, and Li₇La₃Zr₂O₁₂, for example.

The solid electrolyte may include a hydride solid electrolyte, for example. The hydride solid electrolyte may include LiBH₄ and/or the like, for example. The solid electrolyte may include a nitride solid electrolyte, for example. The nitride solid electrolyte may include Li₃N, Li₃BN₂, and/or the like, for example.

### Separator

Battery 100 may include separator 30. Separator 30 is capable of separating positive electrode 10 from negative electrode 20. Separator 30 is electrically insulating. Separator 30 may include a resin film, for example. The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The average pore size of the resin film may be from 0.01 to 1 μm, or from 0.1 to 0.5 μm, for example. “Average pore size” may be measured by mercury porosimetry. The Gurley value of the resin film may be from 50 to 250 s/100cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of polyethylene (PE), polypropylene (PP), polyamide (PA), polyamide-imide (PAI), polyimide (PI), aromatic polyamide (aramid), and polyphenylene ether (PPE), and derivatives of these. The resin film may be formed by stretching, phase separation, and/or the like, for example. The resin film may have a thickness from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

In an all-solid-state battery, the solid electrolyte layer is capable of functioning as separator 30.

### Battery Configuration

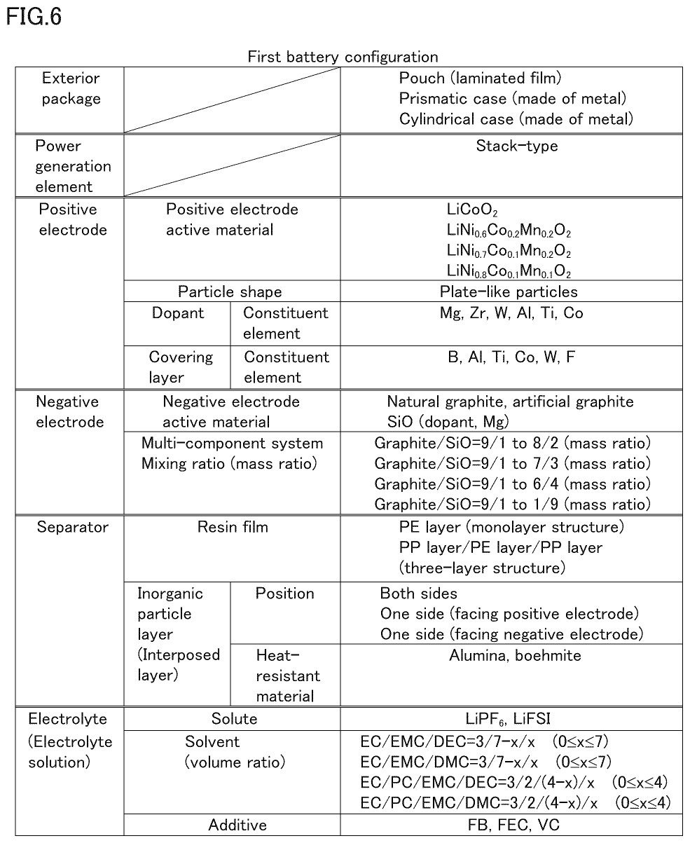

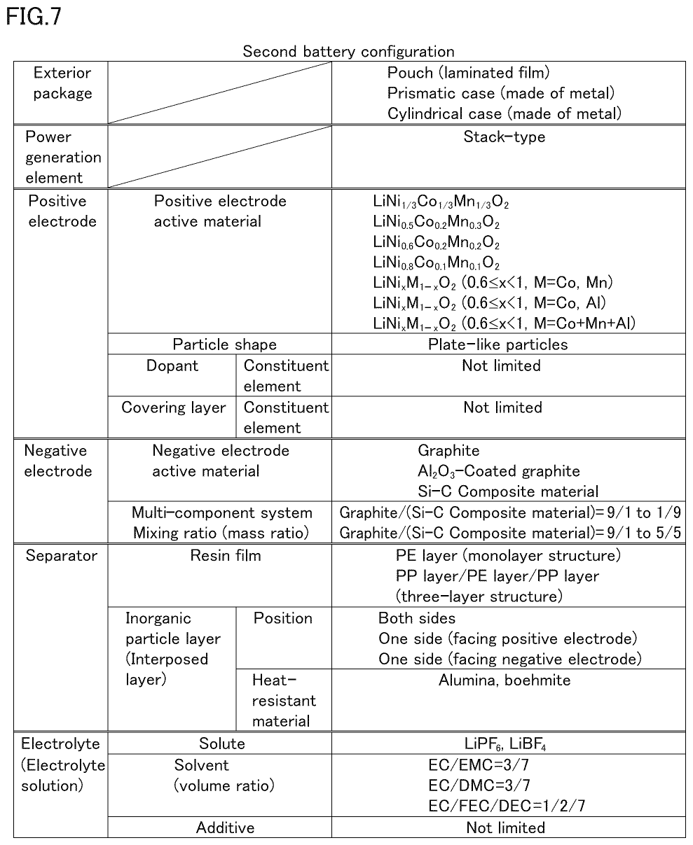

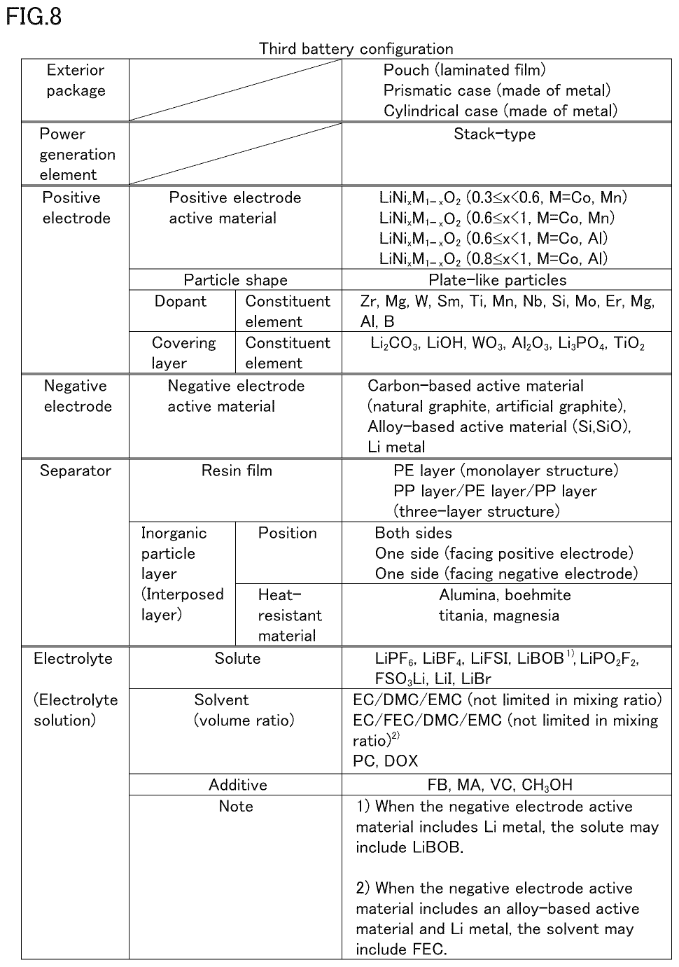

FIG. 6 is a table showing a first battery configuration. FIG. 7 is a table showing a second battery configuration. FIG. 8 is a table showing a third battery configuration. Each battery configuration is an example of the configuration of a liquid-type battery or a polymer battery. Part of each battery configuration may be applied to an all-solid-state battery. In each drawing, when a plurality of types of materials are described in a single cell, this description is intended to mean one of them as well as a combination of them. For example, when materials “α, β, γ” are described in a single cell, this description is intended to mean “at least one selected from the group consisting of α, β, and γ”. Certain elements in these battery configurations may be optionally combined together.

### EXAMPLES

### Production of Positive Electrode Active Material

### No. 1

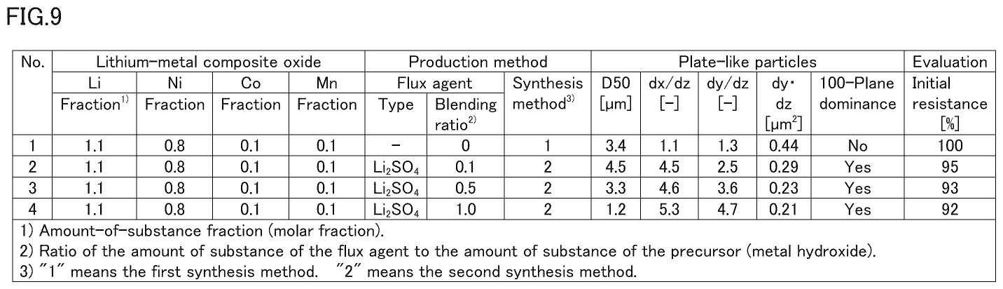

FIG. 9 is a table showing experiment results. By a first synthesis method, a positive electrode active material of No. 1 was produced. NiSO₄, CoSO₄, and MnSO₄ were dissolved in ion-exchanged water to form a raw material solution. In the raw material solution, the molar ratio between Ni, Co, and Mn was “Ni/Co/Mn=8/1/1”. The concentration of the solute in the raw material solution was 30% (mass fraction).

Into a reaction vessel, an aqueous ammonia solution was added. While the aqueous ammonia solution was being stirred with a stirrer, inside the reaction vessel was replaced by nitrogen. Into the reaction vessel, NaOH was further added, and thereby a reaction liquid was formed.

The raw material solution and the aqueous ammonia solution were added dropwise to the reaction liquid so that the pH of the reaction liquid was maintained within a certain range, and thereby a precipitate (metal hydroxide) was formed. The reaction liquid was filtrated to collect the metal hydroxide. The metal hydroxide was dispersed in ion-exchanged water to form a dispersion. The dispersion was sufficiently stirred with a spatula. In other words, the metal hydroxide was rinsed with water. After rinsed with water, the dispersion was filtrated to collect the metal hydroxide. The metal hydroxide was dried at 120° C. for 16 hours, and thereby a dried product was formed.

The dried product and a lithium compound (Li₂CO₃) were mixed together in a mortar to form a mixture. The ratio of the amount of substance of Li to the amount of substance of the metal hydroxide was 1.1.

The mixture was subjected to heat treatment in a muffle furnace, and thereby a lithium-metal composite oxide was synthesized. The heat treatment was performed in one step. The conditions of the heat treatment were as specified below. After the heat treatment, the particle size of the lithium-metal composite oxide was regulated with the use of a jet mill.
Atmosphere: Oxygen atmosphere
Temperature: 800 to 1100° C.
Duration: 10 hours.

### No. 2

By a second synthesis method, a positive electrode active material of No. 2 was produced. The second synthesis method is different from the first synthesis method in that the former uses a flux agent and two-step heat treatment. NiSO₄, CoSO₄, and MnSO₄ were dissolved in ion-exchanged water to form a raw material solution. In the raw material solution, the molar ratio between Ni, Co, and Mn was “Ni/Co/Mn=8/1/1”.The concentration of the solute in the raw material solution was 30% (mass fraction).

Into a reaction vessel, an aqueous ammonia solution was added. While the aqueous ammonia solution was being stirred with a stirrer, inside the reaction vessel was replaced by nitrogen. Into the reaction vessel, NaOH was further added, and thereby a reaction liquid was formed.

The raw material solution and the aqueous ammonia solution were added dropwise to the reaction liquid so that the pH of the reaction liquid was maintained within a certain range, and thereby a precipitate (metal hydroxide) was formed. The reaction liquid was filtrated to collect the metal hydroxide. The metal hydroxide was dispersed in ion-exchanged water to form a dispersion. The dispersion was sufficiently stirred with a spatula. In other words, the metal hydroxide was rinsed with water. After rinsed with water, the dispersion was filtrated to collect the metal hydroxide. The metal hydroxide was dried at 120° C. for 16 hours, and thereby a dried product was formed.

The dried product, a lithium compound (Li₂CO₃), and a flux agent (Li₂SO₄) were mixed together in a mortar to form a mixture. The ratio of the amount of substance of the flux agent to the amount of substance of the metal hydroxide was 0.1.

In a muffle furnace, a first heat treatment and a second heat treatment were performed in this order, and thereby a lithium-metal composite oxide was synthesized. The conditions of the heat treatment were as specified below. After the heat treatment, the particle size of the lithium-metal composite oxide was regulated with the use of a jet mill.
First heat treatment
Atmosphere: Oxygen atmosphere
Temperature: 800° C.
Duration: 10 hours
Second heat treatment
Atmosphere: Oxygen atmosphere
Temperature: 1000° C.
Duration: 5 hours.

### No. 3, No. 4

A positive electrode active material was produced in the same manner as in No. 2 except that the usage of the flux agent was changed as specified in FIG. 9.

### Evaluation

A cylindrical lithium-ion secondary battery (an evaluation cell) was produced. The configuration of the evaluation cell is as described below.
Power generation element: Wound type
Positive electrode: Positive electrode active material/AB/PVDF=88/10/2 (mass ratio)
Negative electrode: Negative electrode active material (natural graphite), CMC, SBR
Electrolyte: LiPF₆ (1 mol/L), EC/DMC/EMC=3/4/3 (volume ratio)

Each of the positive electrode and the negative electrode was produced by applying a slurry to the surface of a base material (a metal foil sheet). As the application apparatus, a film applicator manufactured by Allgood (having film-thickness adjuster function) was used. After the slurry application, the coating film was dried at 80° C. for 5 minutes.

Initial resistance of the evaluation cell was measured. In FIG. 9, in the column “Initial resistance”, relative values are given. Each relative value (in percentage) was calculated by dividing the initial resistance of the evaluation cell by the initial resistance of No. 1. It is evaluated that the lower the initial resistance, the more reduced the battery resistance.

### Results

In No. 1, no plate-like particles were observed. In No. 2 to No. 4, plate-like particles were observed. In No. 2 to No. 4, as compared to No. 1, reduction in battery resistance tended to be observed. It may be because of the increased reaction area.

The greater the anisotropy was, more specifically, the greater the values of “dx/dz” and “dy/dz” were, the greater the 100-plane dominance tended to be.

What is claimed is:

1. A positive electrode active material comprising:
a lithium-metal composite oxide, wherein,
the lithium-metal composite oxide is in a form of a plate-like particle,
the plate-like particle satisfies relationships of 3≤dx/dz and 2≤dy/dz,
dx represents a major-axis diameter of the plate-like particle,
dy represents a minor-axis diameter of the plate-like particle, and
dz represents a thickness of the plate-like particle.

2. The positive electrode active material according to claim 1, wherein the plate-like particle further satisfies a relationship of 0.21≤dy·dz≤0.29.

3. The positive electrode active material according to claim 1, wherein the lithium-metal composite oxide has a lamellar-rock-salt-type structure.

4. The positive electrode active material according to claim 1, wherein the lithium-metal composite oxide has a composition represented by a general formula: 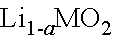
where
a relationship of −0.5≤a≤0.5 is satisfied, and
M includes at least one selected from the group consisting of Ni, Co, Mn, and Al.

5. The positive electrode active material according to claim 1, wherein the plate-like particle consists of a single crystallite.

6. A secondary battery comprising the positive electrode active material according to claim 1.

7. A method of producing a positive electrode active material, the method comprising:
(a) preparing a metal hydroxide;
(b) mixing the metal hydroxide, a lithium compound, and a flux agent to form a mixture; and
(c) performing heat treatment of the mixture in an oxygen atmosphere to synthesize a lithium-metal composite oxide,
wherein
the flux agent includes at least one selected from the group consisting of Li₂SO₄, NaCl, CaCl, LiCl, and LiNO₃, and
in the (c), the lithium-metal composite oxide grows into a plate-like particle.

8. The method of producing a positive electrode active material according to claim 7, wherein in the (b), a ratio of an amount of substance of the flux agent to an amount of substance of the metal hydroxide is from 0.1 to 1.

9. The method of producing a positive electrode active material according to claim 7, wherein
in the (c), a first heat treatment and a second heat treatment are performed in this order,
a temperature in the second heat treatment is 1.2 to 1.4 times a temperature in the first heat treatment, and
a duration of the second heat treatment is 0.1 to 0.5 times a duration of the first heat treatment.
